(19) United States
(12) Patent Application Publication
(10) Pub. No.: US 2015/0372871 A1
(43) Pub. Date: Dec. 24, 2015

(54) Resource Management Method and System in Photoelectric Hybrid System

(71) Applicant: ZTE CORPORATION, Shenzhen City, Guangdong Province (CN)

(72) Inventor: Meiyan ZANG, Shenzhen (CN)

(21) Appl. No.: 14/421,496

(22) PCT Filed: Aug. 30, 2013
(86) PCT No.: PCT/CN2013/082663

§ 371 Date: Feb. 13, 2015

(30) Foreign Application Priority Data
Jan. 30, 2013 (CN) 201310035187.4

(51) Int. Cl. H04L 12/24; H04Q 11/00; H04L 5/16

(52) U.S. Cl. CPC H04L 41/0896; H04L 5/16; H04Q 11/0067; H04Q 2011/0086

(57) ABSTRACT

A method and system for managing resources in a photoelectric hybrid system are disclosed. The method includes: for a Coaxial Network Unit (CNU) operating in a half-duplex operating mode, an Optical Line Terminal (OLT) managing uplink bandwidth resources of the CNU according to uplink bandwidth information of the CNU and an ONU; and the OLT and an OCU together managing downlink bandwidth resources of the CNU.

### TECHNICAL FIELD

The present document relates to a network communication system, and in particular, to a method and system for scheduling resources in a photoelectric hybrid system.

### BACKGROUND OF THE RELATED ART

A basic trend in the development of the next generation network is an IP-based full service network. For cable operators, such as radio and television, in order to make full use of a large number of existing home-entry cables thereof, a hybrid networking network reconstruction scheme of a Passive Optical Network (PON) and an Ethernet over Cable (EOC) is provided, and hybrid networking of the PON and the EOC is generally represented as “PON+EOC”. With reference to a diagram of a typical network of PON+EOC shown in FIG. 1, the network includes a PON, an EOC and a background management system, wherein, the PON includes an Optical Line Terminal (OLT), an Optical Distributed network (ODN), and an optical layer part in an Optical Coax Unit (OCU), and the EOC includes an electrical layer part of the OCU, and a Coaxial Network Unit (CNU). Wherein, the OCU may be an integrated device as shown in FIG. 1, or may also be comprised of two devices, i.e., an Optical network Unit (ONC) of the OCU and a Coaxial Line Terminal (CLT) of the OCU. The OCU is a head end device in the EOC scheme, and the CNU is a terminal device in the EOC scheme.

With reference to a diagram of a network of PON+EPoC as shown in FIG. 2, the network is a specific form of the network of the PON+EOC. In the whole system architecture illustrated in the diagram of the network, the optical layer part includes OLT+ODN+ an optical layer module of EPoC OCU, and the electrical part includes an electrical layer module of EPoC OCU+Coaxial Distributed Unit (CDN)+CNU. In the architecture, a user side of the CNU and OCU is a Coax-based physical layer, but the MAC will reuse the MAC of the EPON.

Under this architecture, as the optical layer part is in a FDD operating mode as a full-duplex mode, if the electrical layer part uses a half-duplex operating module, for example, a TDD mode, there will be a problem of coordination between the full-duplex mode and the half-duplex mode. It needs to consider how to avoid the problem of confliction in the half-duplex operating mode while effectively allocating resources to the CNU.

### SUMMARY

The present document provides a method and system for scheduling resources in a photoelectric hybrid system, and the technical problem to be solved is how to manage bandwidth resources of the CNU operating in a half-duplex mode to avoid the problem of bandwidth resources when the optical layer part is in a FDD operating mode as a full-duplex mode and the electrical layer part uses a half-duplex operating mode.

In order to solve the above technical problem, the present document provides the following technical schemes:

A method for managing resources in a photoelectric hybrid system, comprising:

for a Coaxial Network Unit (CNU) operating in a half-duplex operating mode, an Optical Line Terminal (OLT) managing uplink bandwidth resources of the CNU according to uplink bandwidth information of the CNU and an Optical Network Unit (ONU); and the OLT and an Optical Coax Unit (OCU) together managing downlink bandwidth resources of the CNU.

Preferably, the method further comprises the following features: the OLT manages the uplink bandwidth resources of the CNU using a Dynamic Bandwidth Allocation (DBA) mechanism defined in an Ethernet Passive Optical Network (EPON) standard.

Preferably, the method further comprises the following features: the OLT performing management in conjunction with the uplink bandwidth information of the ONU comprises:

the OLT managing the uplink bandwidth resources of the CNU according to uplink bandwidth requirements of the ONU and the CNU; or

the OLT managing the uplink bandwidth resources of the CNU according to the uplink bandwidth requirements of the ONU and the CNU and information of a maximum uplink bandwidth that can be supported by a coaxial side between the CNU and the OCU.

Preferably, the method further comprises the following features: the OLT and the OCU together managing the CNU comprises:

the OLT acquiring information of an information rate of the CNU and information of a maximum downlink bandwidth that can be supported by a coaxial side between the CNU and the OCU;

after receiving a downlink message, the OLT performing reshaping processing on the downlink message according to the acquired information of the information rate and the maximum downlink bandwidth;

the OLT transmitting the reshaped downlink message to the OCU;

after acquiring a downlink message of the CNU which is connected locally and operates in a half-duplex mode from received messages, the OCU allocating to the CNU downlink slot resources which do not conflict with uplink slot resources according to information of the uplink slot resources allocated by the OLT to the CNU; and

the OCU transmitting the reshaped downlink message to the CNU in the range of the downlink slot resources.

Preferably, the method further comprises the following features: the information of the information rate comprises at least one of Committed Information Rate (CIR) information and Peak Information Rate (PIR) information.

Preferably, the method further comprises the following features: the OCU acquiring a message of the CNU which is connected locally and is in a half-duplex mode comprises:

after receiving downlink messages, the OCU performing downlink filtering according to identifier information of the CNU connected to the OCU which is pre-stored locally, to obtain the downlink message of the CNU connected to the OCU; and selecting the downlink message of the CNU which operates in a half-duplex mode from filtered downlink messages according to an operating mode of the CNU connected to the OCU.

Preferably, the method further comprises the following features: architecture of an optical layer part in the photoelectric hybrid system operates in a full-duplex operating mode, and architecture of an electrical layer part in the photoelectric hybrid system uses a half-duplex operating mode.

A system for managing resources in a photoelectric hybrid system, comprising an Optical Line Terminal (OLT) and an Optical Coax Unit (OCU), wherein,

the OLT comprises:

an uplink management apparatus, configured to manage uplink bandwidth resources of a Coaxial Network Unit (CNU) operating in a half-duplex operating mode according to uplink bandwidth information of the CNU and the ONU; and

a first downlink management apparatus, configured to manage downlink bandwidth resources of the CNU; and

the OCU is configured to be connected to the OLT, and comprises:

a second downlink management apparatus, configured to manage the downlink bandwidth resources of the CNU.

Preferably, the system further comprises the following features: the uplink management apparatus manages the uplink bandwidth resources of the CNU using a Dynamic Bandwidth Allocation (DBA) mechanism defined in an Ethernet Passive Optical Network (EPON) standard.

Preferably, the system further comprises the following features: the uplink management apparatus is configured to:

manage the uplink bandwidth resources of the CNU according to uplink bandwidth requirements of the ONU and the CNU; or

manage the uplink bandwidth resources of the CNU according to the uplink bandwidth requirements of the ONU and the CNU and information of a maximum uplink bandwidth that can be supported by a coaxial side between the CNU and the OCU.

Preferably, the system further comprises the following features: the first downlink management apparatus comprises:

an acquisition module, configured to acquire information of an information rate of the CNU and information of a maximum downlink bandwidth that can be supported by a coaxial side between the CNU and the OCU;

a processing module, configured to be connected to the acquisition module, and after receiving a downlink message of the CNU, perform reshaping processing on the downlink message according to a Committed Information Rate (CIR) and a Peak Information Rate (PIR) of the CNU as well as the information of the maximum downlink bandwidth that can be supported by the coaxial side between the OCU and the CNU;

a first transmission module, configured to be connected to the processing module, and transmit the reshaped downlink message to the OCU;

the second downlink management apparatus comprises:

an allocation module, configured to allocate to the CNU downlink slot resources which do not conflict with uplink slot resources according to a condition of the uplink slot resources allocated by the OLT to the CNU after acquiring a downlink message of the CNU which is connected locally and operates in a half-duplex mode; and

a second transmission module, configured to be connected to the first transmission module and the allocation module, and transmit the reshaped downlink message to the CNU in the range of the downlink slot resources.

Preferably, the system further comprises the following features: the information of the information rate comprises at least one of Committed Information Rate (CIR) information and Peak Information Rate (PIR) information.

Preferably, the system further comprises the following features: the second downlink management apparatus further comprises:

a filtering module, configured to perform downlink filtering according to identifier information of the CNU connected to the OCU which is pre-stored locally after receiving downlink messages, to obtain the downlink message of the CNU connected to the OCU; and

a selection module, configured to be connected to the filtering module and the allocation module, and select the downlink message of the CNU which operates in a half-duplex mode from filtered downlink messages according to an operating mode of the CNU connected to the OCU.

Preferably, the system further comprises the following features: architecture of an optical layer part in the photoelectric hybrid system operates in a full-duplex operating mode, and architecture of an electrical layer part in the photoelectric hybrid system uses a half-duplex operating mode.

The embodiments of the present invention use the OLT and the OCU in conjunction to schedule, control and allocate uplink and downlink slot resources of the CNU in order to prevent conflict from occurring in forwarding of uplink and downlink data of the CNU operating in a half-duplex operating mode (such as a TDD mode) while not influencing the existing EPON standard. The OCU merely monitors the uplink slot resources, and control and allocation of downlink slot resources as well as other controls of the CNU are also performed by the OLT, to ensure that the related requirements of the CNU operating in the half-duplex mode are satisfied while not increasing the complexity and cost of the OCU.

### BRIEF DESCRIPTION OF DRAWINGS

FIG. 1 is a diagram of architecture of a typical PON+EOC system in the related technology;

FIG. 2 is a diagram of architecture of a PON+EpoC system in the related technology;

FIG. 3 is a flowchart of a method embodiment of managing uplink bandwidth resources in a photoelectric hybrid system according to the present document;

FIG. 4 is a diagram of an OLT scheduling uplink resources of a CNU and an ONU according to an embodiment of the present invention;

FIG. 5 is a flowchart of a method embodiment of managing downlink bandwidth resources in a photoelectric hybrid system according to an embodiment of the present invention; and

FIG. 6 is a diagram of an OLT scheduling downlink resources of a CNU and an ONU according to an embodiment of the present invention.

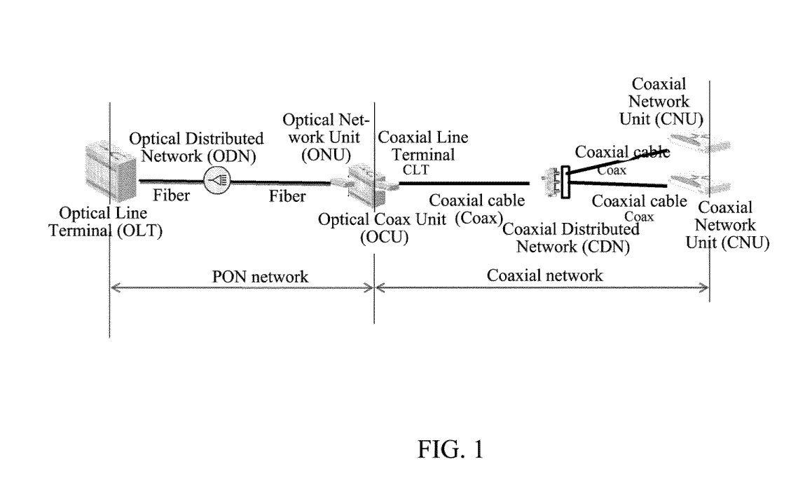

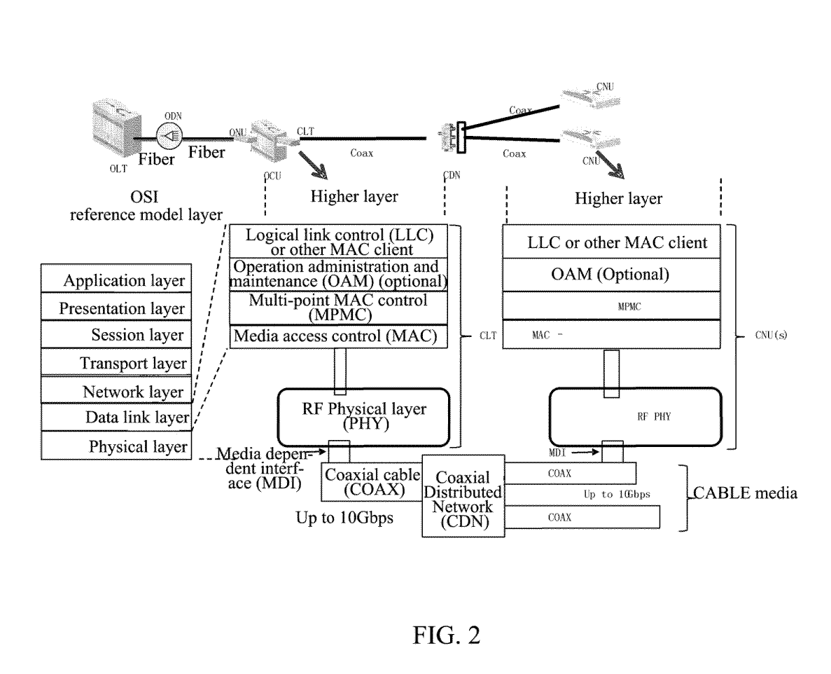

### PREFERRED EMBODIMENTS OF THE PRESENT INVENTION

The present document will be further described in detail below in conjunction with accompanying drawings and specific embodiments. It should be illustrated that without a conflict, the embodiments in the present application and features in the embodiments can be combined with each other randomly.

The present document provides a method for managing resources in a photoelectric hybrid system, comprising:

for a CNU operating in a half-duplex operating mode, an OLT managing uplink bandwidth resources of the CNU according to uplink bandwidth information of the CNU and an ONU; and the OLT and an OCU together managing downlink bandwidth resources of the CNU.

The method according to the present document will be further described below:

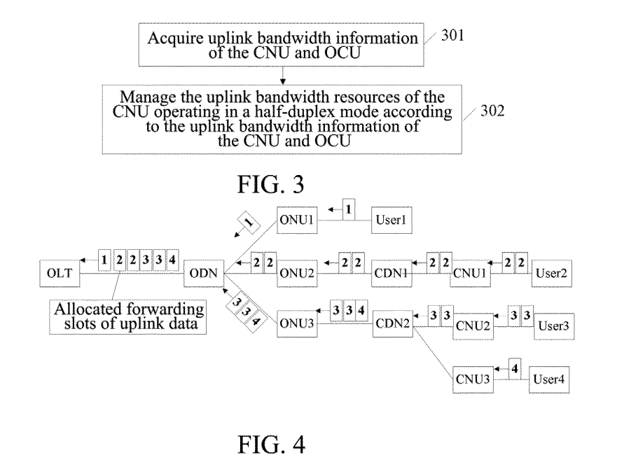

FIG. 3 is a flowchart of a method embodiment of managing uplink bandwidth resources in a photoelectric hybrid system according to the present document. In the photoelectric hybrid system according to the method embodiment illustrated in FIG. 3, the architecture of the optical layer part operates in a full-duplex operating mode, and the architecture of the electrical layer part uses a half-duplex operating mode.

In step 301, an OLT acquires uplink bandwidth information of the CNU and the OCU;

In step 302, the OLT manages the uplink bandwidth resources of the CNU operating in a half-duplex mode according to the uplink bandwidth information of the CNU and the OCU.

Specifically, in the photoelectric hybrid system, the architecture of the optical layer part operates in a full-duplex operating mode, and the architecture of the electrical layer part uses a half-duplex operating mode, which will results in a conflict in management of the uplink bandwidth resources. Therefore, when the CNU operates in a half-duplex operating mode and the uplink bandwidth resources of the CNU are managed, the OLT manages the uplink bandwidth resources of the CNU according to uplink bandwidth requirements of the ONU and the CNU; or the OLT manages the uplink bandwidth resources of the CNU according to the uplink bandwidth requirements of the ONU and the CNU and information of the maximum uplink bandwidth that can be supported by a coaxial side between the CNU and the OCU. When the OLT manages the uplink resources, a Dynamic Bandwidth Allocation (DBA) mechanism defined in an Ethernet Passive Optical Network (EPON) standard may be used.

As shown in FIG. 4, for the scheduling of uplink resources of the CNU, as the uplink is in a burst transmission mode, in order to prevent a conflict from occurring when the CNU and the ONU transmit data in the uplink, the OLT comprehensively considers the bandwidth requirements of the CNU and the ONU according to the DBA mechanism defined in the existing EPON standard. Wherein, the bandwidth requirements of the CNU and the ONU may be determined by report messages transmitted respectively by them, to schedule the uplink of the CNU and the ONU together. The uplink resources of the CNU and the ONU are scheduled in accordance with a manner for scheduling uplink resources of the ONU by the OLT in the existing EPON system. For allocation of the uplink resources of the CNU, in addition to considering the bandwidth requirements in the report messages, a maximum bandwidth capability which can be supported by a coaxial side between the CNU and the OCU may also need to be considered.

It can be seen that for scheduling of the uplink resources of the CNU, the OLT uses the DBA mechanism defined in the existing EPON standard for unified scheduling and management of the ONU and the CNU.

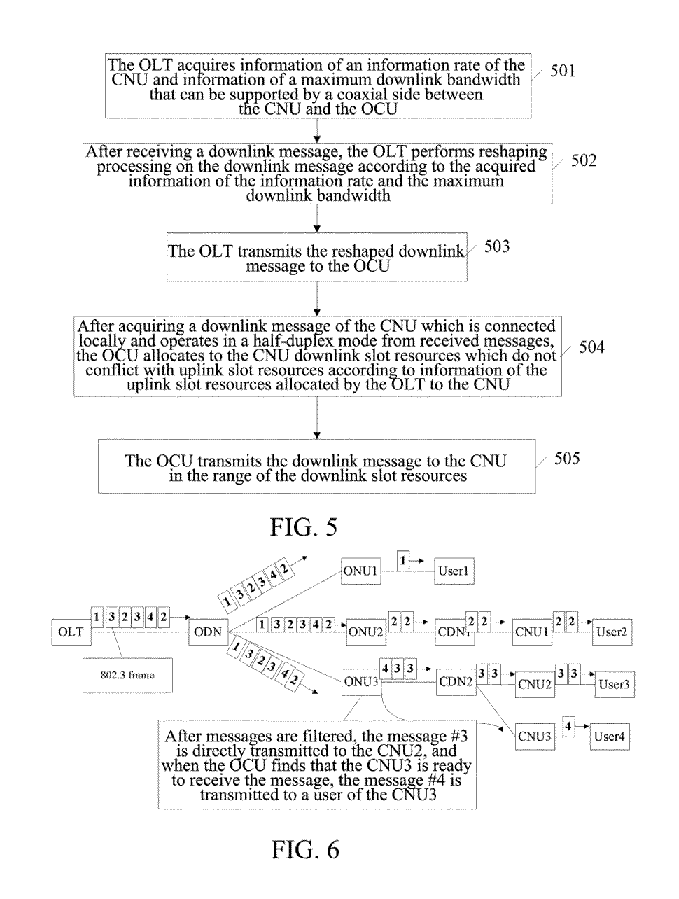

FIG. 5 is a flowchart of a method embodiment of managing downlink bandwidth resources in a photoelectric hybrid system according to an embodiment of the present invention. In the photoelectric hybrid system according to the method embodiment illustrated in FIG. 5, the architecture of the optical layer part operates in a full-duplex operating mode, and the architecture of the electrical layer part uses a half-duplex operating mode.

In step 501, the OLT acquires information of an information rate of the CNU and information of the maximum downlink bandwidth that can be supported by a coaxial side between the CNU and the OCU;

in step 502, after receiving a downlink message, the OLT performs reshaping processing on the downlink message according to the acquired information of the information rate and the maximum downlink bandwidth;

in step 503, the OLT transmits the reshaped downlink message to the OCU;

in step 504, after acquiring a downlink message of the CNU which is connected locally and operates in a half-duplex mode from received messages, the OCU allocates to the CNU downlink slot resources which do not conflict with uplink slot resources according to information of the uplink slot resources allocated by the OLT to the CNU; and

in step 505, the OCU transmits the downlink message to the CNU in the range of the downlink slot resources.

For scheduling of the downlink resources of the CNU, as the CNU operates in a TDD mode, which is a half-duplex operating mode, if the scheduling of slots is not reasonable, a phenomenon of a conflict between uplink and downlink will occur. If the existing EPON standard is not modified and the existing MPCP protocol is reused, the OLT and the OCU need to operate in cooperation to decide the scheduling and allocation of downlink resources of the CNU, so as to prevent a conflict between downlink transmission and uplink transmission of the CNU from occurring.

Wherein, the information of the information rate comprises at least one of Committed Information Rate (CIR) information and Peak Information Rate (PIR) information.

the OCU acquiring a message of the CNU which is connected locally and is in a half-duplex mode comprises:

after receiving downlink messages, the OCU performing downlink filtering according to identifier information of the CNU connected to the OCU which is pre-stored locally, to obtain the downlink message of the CNU connected to the OCU; and

selecting the downlink message of the CNU which operates in a half-duplex mode from filtered downlink messages according to an operating mode of the CNU connected to the OCU.

The above method embodiment will be further described below.

As shown in FIG. 6, for scheduling of downlink resources of the CNU, as the CNU operates in a TDD mode, which is a half-duplex operating mode, if the scheduling of slots is not reasonable, a phenomenon of a conflict between uplink and downlink will occur. If the existing EPON standard is not modified and the existing MPCP protocol is reused, the OLT and the OCU need to operate in cooperation to decide the scheduling and allocation of downlink resources of the CNU, so as to prevent a conflict between uplink and downlink of the CNU from occurring. The process specifically comprises:

the OLT performing reshaping processing on the downlink message according to information such as the configured CIR, PIR, a maximum downlink bandwidth that can be supported between the OCU and the CNU, and then transmitting the message to the OCU;

after receiving the message, the OCU performing filtering according to the recorded identifier of the CNU such as a Logical Link Identifier (LLID), and discarding downlink data streams which do not belong to the CNU connected thereto, to obtain downlink data streams which belong to the CNU connected thereto;

directly forwarding data streams which belong to the CNU operating in a full-duplex operating mode and being connected thereto; buffering data streams which belong to the CNU operating in a TDD mode (half-duplex operating mode) and being connected thereto, and allocating other slot resources which do not conflict with the slot resources for the uplink data transmission as downlink data transmission resources according to a condition of the uplink slot resources allocate by the OLT to the CNU. That is, the CNU is ready to receive the downlink data in the slot range and transmit the downlink message to the CNU in the slot range, so as to ensure normal uplink and downlink data forwarding process in a case that the conflict is avoided.

In conclusion, with the present document, the OLT and the OCU operate in conjunction to allocate uplink and downlink operation bandwidths to the CNU operating in a TDD mode in the PON+EOC, especially in a photoelectric hybrid system of the EPoC. The OLT allocates uplink slots to the CNU using a DBA operating mechanism in the existing EPON standard, and the OCU allocates and controls downlink slots of the CNU according to a condition of allocation of the uplink slots of the CNU. Without modifying and extending the existing MPCP protocol, for the CNU operating in a half-duplex operating mode, the OCU participates in scheduling and allocation of the downlink resources, and completes forwarding and control of the downlink data of the OCU together with the OLT. While for the uplink, the existing DBA mechanism is still used. Other control and management of the CNU are still achieved and completed by the OLT. On the basis of satisfying a low cost and low complexity of the OCU as much as possible while the EPoC system may be compatible with the existing OLT and DOCSIS background management system, forwarding of uplink and downlink data streams of the CNU in a half-duplex operating mode is achieved.

Corresponding to the above method, the present document provides a system for managing resources in a photoelectric hybrid system, comprising an OLT and an OCU, wherein,

the OLT comprises:

an uplink management apparatus, used to manage uplink bandwidth resources of a CNU operating in a half-duplex operating mode according to uplink bandwidth information of the CNU and the ONU; and

a first downlink management apparatus, used to manage downlink bandwidth resources of the CNU; and

the OCU is configured to be connected to the OLT, and comprises:

a second downlink management apparatus, used to manage the downlink bandwidth resources of the CNU.

wherein, the uplink management apparatus manages the uplink bandwidth resources of the CNU using a Dynamic Bandwidth Allocation (DBA) mechanism defined in an Ethernet Passive Optical Network (EPON) standard.

Wherein, the uplink management apparatus is used to:

manage the uplink bandwidth resources of the CNU according to uplink bandwidth requirements of the ONU and the CNU; or

manage the uplink bandwidth resources of the CNU according to the uplink bandwidth requirements of the ONU and the CNU and information of the maximum uplink bandwidth that can be supported by a coaxial side between the CNU and the OCU.

wherein, the first downlink management apparatus comprises:

an acquisition module, used to acquire information of an information rate of the CNU and information of the maximum downlink bandwidth that can be supported by a coaxial side between the CNU and the OCU;

a processing module, configured to be connected to the acquisition module, and after receiving a downlink message of the CNU, perform reshaping processing on the downlink message according to a Committed Information Rate (CIR) and a Peak Information Rate (PIR) of the CNU as well as information of the maximum downlink bandwidth that can be supported by a coaxial side between the OCU and the CNU;

a first transmission module, configured to be connected to the processing module, and transmit the reshaped downlink message to the OCU;

the second downlink management apparatus comprises:

an allocation module, used to allocate to the CNU downlink slot resources which do not conflict with uplink slot resources according to a condition of the uplink slot resources allocated by the OLT to the CNU after acquiring a downlink message of the CNU which is connected locally and operates in a half-duplex mode; and

a second transmission module, configured to be connected to the first transmission module and the allocation module, and transmit the reshaped downlink message to the CNU in the range of the downlink slot resources.

wherein, the information of the information rate comprises at least one of Committed Information Rate (CIR) information and Peak Information Rate (PIR) information.

Wherein, the second downlink management apparatus further comprises:

a filtering module, used to perform downlink filtering according to identifier information of the CNU connected to the OCU which is pre-stored locally after receiving downlink messages, to obtain the downlink message of the CNU connected to the OCU; and

a selection module, configured to be connected to the filtering module and the allocation module, and select the downlink message of the CNU which operates in a half-duplex mode from filtered downlink messages according to an operating mode of the CNU connected to the OCU.

wherein, architecture of an optical layer part in the photoelectric hybrid system operates in a full-duplex operating mode, and architecture of an electrical layer part in the photoelectric hybrid system uses a half-duplex operating mode.

The system embodiments of the present invention use the OLT and the OCU in conjunction to schedule, control and allocate uplink and downlink slot resources of the CNU in order to prevent conflict from occurring in forwarding of uplink and downlink data of the CNU operating in a half-duplex operating mode (such as a TDD mode) while not influencing the existing EPON standard. The OCU merely monitors the uplink slot resources, and control and allocation of downlink slot resources as well as other controls of the CNU are also performed by the OLT, to ensure that the related requirements of the CNU operating in the half-duplex mode are satisfied while not increasing the complexity and cost of the OCU.

A person having ordinary skill in the art can understand that all or a part of steps in the above embodiments can be implemented by computer program flow, which can be stored in a computer readable storage medium, is performed on a corresponding hardware platform (for example, a system, a device, an apparatus, and a component etc.), and when performed, comprises one of steps of the method embodiment or a combination thereof.

Alternatively, all or a part of steps in the above embodiments can also be implemented by integrated circuits, can be respectively made into a plurality of integrated circuit modules; alternatively, it is implemented with making several modules or steps of them into a single integrated circuit module. Thus, the present document is not limited to any specific combinations of hardware and software.

Each module or functional module or functional unit in the aforementioned embodiments can be implemented with general computing apparatuses, and can be integrated in a single computing apparatus, or distributed onto a network consisting of a plurality of computing apparatuses.

When each module or functional module or functional unit in the aforementioned embodiments is implemented in a form of software functional modules and is sold or used as an independent product, it can be stored in a computer readable storage medium, which may be a read-only memory, a disk or a disc etc.

The above description is merely specific implementations of the present document, but the protection scope of the present document is not limited thereto. Changes or substitutions can easily be reached by a person having ordinary skill in the art within the technical scope disclosed by the present document, and should be included in the protection scope of the present-document. Therefore, the protection scope of the present document is defined by the protection scope of the claims.

### INDUSTRIAL APPLICABILITY

The embodiments of the present invention use the OLT and the OCU in conjunction to schedule, control and allocate uplink and downlink slot resources of the CNU in order to prevent conflict from occurring in forwarding of uplink and downlink data of the CNU operating in a half-duplex operating mode (such as a TDD mode) while not influencing the existing EPON standard. The OCU merely monitors the uplink slot resources, and control and allocation of downlink slot resources as well as other controls of the CNU are also performed by the OLT, to ensure that the related requirements of the CNU operating in the half-duplex mode are satisfied while not increasing the complexity and cost of the OCU.

What is claimed is:

1. A method for managing resources in a photoelectric hybrid system, comprising:
for a Coaxial Network Unit (CNU) operating in a half-duplex operating mode, an Optical Line Terminal (OLT) managing uplink bandwidth resources of the CNU according to uplink bandwidth information of the CNU and an Optical Network Unit (ONU); and the OLT and an Optical Coax Unit (OCU) together managing downlink bandwidth resources of the CNU.

2. The method according to claim 1, wherein, the OLT manages the uplink bandwidth resources of the CNU using a Dynamic Bandwidth Allocation (DBA) mechanism defined in an Ethernet Passive Optical Network (EPON) standard.

3. The method according to claim 1, wherein, the OLT performing management in conjunction with the uplink bandwidth information of the ONU comprises:
the OLT managing the uplink bandwidth resources of the CNU according to uplink bandwidth requirements of the ONU and the CNU; or
the OLT managing the uplink bandwidth resources of the CNU according to the uplink bandwidth requirements of the ONU and the CNU and information of a maximum uplink bandwidth that can be supported by a coaxial side between the CNU and the OCU.

4. The method according to claim 1, wherein, the OLT and the OCU together managing the CNU comprises:
the OLT acquiring information of an information rate of the CNU and information of a maximum downlink bandwidth that can be supported by a coaxial side between the CNU and the OCU;
after receiving a downlink message, the OLT performing reshaping processing on the downlink message according to the acquired information of the information rate and the maximum downlink bandwidth;
the OLT transmitting the reshaped downlink message to the OCU;
after the OCU acquires a downlink message of the CNU which is connected locally and operates in the half-duplex mode from received messages, the OCU allocating to the CNU downlink slot resources which do not conflict with uplink slot resources according to information of the uplink slot resources allocated by the OLT to the CNU; and
the OCU transmitting the reshaped downlink message to the CNU in the range of the downlink slot resources.

5. The method according to claim 4, wherein, the information of the information rate comprises at least one of Committed Information Rate (CIR) information and Peak Information Rate (PIR) information.

6. The method according to claim 4, wherein, the OCU acquiring a message of the CNU which is connected locally and is in the half-duplex mode comprises:
after the OCU receives downlink messages, the OCU performing downlink filtering according to identifier information of the CNU connected to the OCU which is pre-stored locally, to obtain the downlink message of the CNU connected to the OCU; and selecting the downlink message of the CNU which operates in the half-duplex mode from filtered downlink messages according to an operating mode of the CNU connected to the OCU.

7. The method according to claim 1, wherein, architecture of an optical layer part in the photoelectric hybrid system operates in a full-duplex operating mode, and architecture of an electrical layer part in the photoelectric hybrid system uses the half-duplex operating mode.

8. A system for managing resources in a photoelectric hybrid system, comprising an Optical Line Terminal (OLT) and an Optical Coax Unit (OCU), wherein,
the OLT comprises:
an uplink management apparatus, configured to manage uplink bandwidth resources of a Coaxial Network Unit (CNU) operating in a half-duplex operating mode according to uplink bandwidth information of the CNU and the ONU; and
a first downlink management apparatus, configured to manage downlink bandwidth resources of the CNU; and
the OCU is configured to be connected to the OLT, and comprises:
a second downlink management apparatus, configured to manage the downlink bandwidth resources of the CNU.

9. The system according to claim 8, wherein, the uplink management apparatus manages the uplink bandwidth resources of the CNU using a Dynamic Bandwidth Allocation (DBA) mechanism defined in an Ethernet Passive Optical Network (EPON) standard.

10. The system according to claim 8, wherein, the uplink management apparatus is configured to:
manage the uplink bandwidth resources of the CNU according to uplink bandwidth requirements of the ONU and the CNU; or
manage the uplink bandwidth resources of the CNU according to the uplink bandwidth requirements of the ONU and the CNU and information of a maximum uplink bandwidth that can be supported by a coaxial side between the CNU and the OCU.

11. The system according to claim 8, wherein,
the first downlink management apparatus comprises:
an acquisition module, configured to acquire information of an information rate of the CNU and information of a maximum downlink bandwidth that can be supported by a coaxial side between the CNU and the OCU;
a processing module, configured to be connected to the acquisition module, and after receiving a downlink message of the CNU, perform reshaping processing on the downlink message according to a Committed Information Rate (CIR) and a Peak Information Rate (PIR) of the CNU as well as the information of the maximum downlink bandwidth that can be supported by the coaxial side between the OCU and the CNU;
a first transmission module, configured to be connected to the processing module, and transmit the reshaped downlink message to the OCU;
the second downlink management apparatus comprises:
an allocation module, configured to allocate to the CNU downlink slot resources which do not conflict with uplink slot resources according to a condition of the uplink slot resources allocated by the OLT to the CNU after acquiring a downlink message of the CNU which is connected locally and operates in the half-duplex mode; and
a second transmission module, configured to be connected to the first transmission module and the allocation module, and transmit the reshaped downlink message to the CNU in the range of the downlink slot resources.

12. The system according to claim 11, wherein, the information of the information rate comprises at least one of Committed Information Rate (CIR) information and Peak Information Rate (PIR) information.

13. The system according to claim 11, wherein, the second downlink management apparatus further comprises:
a filtering module, configured to perform downlink filtering according to identifier information of the CNU connected to the OCU which is pre-stored locally after receiving downlink messages, to obtain the downlink message of the CNU connected to the OCU; and
a selection module, configured to be connected to the filtering module and the allocation module, and select the downlink message of the CNU which operates in the half-duplex mode from filtered downlink messages according to an operating mode of the CNU connected to the OCU.

14. The system according to claim 8, wherein, architecture of an optical layer part in the photoelectric hybrid system operates in a full-duplex operating mode, and architecture of an electrical layer part in the photoelectric hybrid system uses the half-duplex operating mode.
